(19) United States
(12) Patent Application Publication
(10) Pub. No.: US 2025/0280339 A1
(43) Pub. Date: Sep. 4, 2025

(54) Layer 1 Measurements in Concurrent Measurement Gaps

(71) Applicant: Apple Inc., CUPERTINO, CA (US)

(72) Inventors: Qiming LI, Beijing (CN); Dawei ZHANG, Saratoga, CA (US); Huaning NIU, San Jose, CA (US); Jie CUI, San Jose, CA (US); Manasa RAGHAVAN, Sunnyvale, CA (US); Xiang CHEN, Campbell, CA (US); Yang TANG, San Jose, CA (US)

(21) Appl. No.: 18/702,546

(22) PCT Filed: Oct. 22, 2021
(86) PCT No.: PCT/CN2021/125694

§ 371 Date: Apr. 18, 2024

(51) Int. Cl. H04W 36/00; H04B 7/06; H04B 17/318; H04W 24/10

(52) U.S. Cl. CPC H04W 36/0088; H04B 7/0626; H04B 7/06952; H04B 17/328; H04W 24/10

(57) ABSTRACT

A user equipment (UE) is configured to receive a layer 1 (L1) measurement configuration for serving cell L1 measurements, receive a measurement gap configuration comprising multiple independent measurement gap patterns for performing radio resource management (RRM) measurements, wherein the measurement gap configuration further comprises an indication that measurement opportunities associated with measurement gaps of one of the multiple independent measurement gap patterns are to be shared with the serving cell L1 measurements and perform the serving cell L1 measurements and the RRM measurements in accordance with the L1 measurement configuration and the measurement gap configuration.

### TECHNICAL FIELD

The present disclosure generally relates to wireless communication, and in particular, to layer 1 measurements in concurrent measurement gaps.

### BACKGROUND INFORMATION

In 5G NR, a user equipment (UE) may perform measurements on one or more reference signals to determine channel properties. Some of these measurements may be referred to as layer 1 (L1) (physical layer) measurements. L1 measurements include Radio Link Monitoring (RLM) measurements, Beam Failure Detection (BFD) measurements, Candidate Beam Discovery (CBD) measurements, reference signal received power (L1-RSRP) measurements and signal-to-noise and interference ratio (L1-SINR) measurements. The L1 measurements may be determined from reference signals including a system synchronization block (SSB) or Channel State Information reference signals (CSI-RS) transmitted by a serving cell.

Other measurements may include radio resource management (RRM) measurements such as layer 3 (L3) radio resource control (RRC) layer measurements. Some of the L3 measurements may be performed during a measurement gap. A measurement gap may be configured for the UE during which the UE may tune away from the current serving cell to neighbor cells. When the L1 and measurement gap are scheduled for the same time and the UE tunes away from the current serving cell, the UE cannot perform both types of measurements simultaneously, e.g., L1 measurements on serving cell and L3 measurements on neighbor cells. There needs to be a mechanism to determine which measurements the UE should perform.

### SUMMARY

Some exemplary embodiments are related to a processor of a user equipment (UE) configured to perform operations. The operations include receiving a layer 1 (L1) measurement configuration for serving cell L1 measurements, receiving a measurement gap configuration comprising multiple independent measurement gap patterns for performing radio resource management (RRM) measurements, wherein the measurement gap configuration further comprises an indication that measurement opportunities associated with measurement gaps of one of the multiple independent measurement gap patterns are to be shared with the serving cell L1 measurements and performing the serving cell L1 measurements and the RRM measurements in accordance with the L1 measurement configuration and the measurement gap configuration.

Other exemplary embodiments are related to a user equipment (UE) having a transceiver configured to connect to a serving cell and a processor communicatively coupled to the transceiver and configured to perform operations. The operations include receiving a layer 1 (L1) measurement configuration for serving cell L1 measurement, receiving a measurement gap configuration comprising multiple independent measurement gap patterns for performing radio resource management (RRM) measurements, wherein the measurement gap configuration further comprises an indication that measurement opportunities associated with measurement gaps of one of the multiple independent measurement gap patterns are to be shared with the serving cell L1 measurements and performing the serving cell L1 measurements and the RRM measurements in accordance with the L1 measurement configuration and the measurement gap configuration.

Still further exemplary embodiments are related to a processor of a base station configured to perform operations. The operations include transmitting, to a user equipment (UE), a layer 1 (L1) measurement configuration for serving cell L1 measurements and transmitting, to the UE, a measurement gap configuration comprising multiple independent measurement gap patterns for performing radio resource management (RRM) measurements, wherein the measurement gap configuration further comprises an indication that measurement opportunities associated with measurement gaps of one of the multiple independent measurement gap patterns are to be shared with the serving cell L1 measurements, wherein the UE is to perform the serving cell L1 measurements and the RRM measurements in accordance with the L1 measurement configuration and the measurement gap configuration.

Additional exemplary embodiments are related to a base station having a transceiver configured to communicate with a user equipment (UE) and a processor communicatively coupled to the transceiver and configured to perform operations. The operations include transmitting, to a user equipment (UE), a layer 1 (L1) measurement configuration for serving cell L1 measurements and transmitting, to the UE, a measurement gap configuration comprising multiple independent measurement gap patterns for performing radio resource management (RRM) measurements, wherein the measurement gap configuration further comprises an indication that measurement opportunities associated with measurement gaps of one of the multiple independent measurement gap patterns are to be shared with the serving cell L1 measurements, wherein the UE is to perform the serving cell L1 measurements and the RRM measurements in accordance with the L1 measurement configuration and the measurement gap configuration.

### BRIEF DESCRIPTION OF THE DRAWINGS

FIG. 1 shows a network arrangement according to various exemplary embodiments.

FIG. 2 shows an exemplary UE according to various exemplary embodiments.

FIG. 3 shows an exemplary base station according to various exemplary embodiments.

FIGS. 4A-F show examples of independent measurement gap patterns.

FIG. 5 shows a first timing diagram including two independent measurement gap patterns and configured SSBs according to various exemplary embodiments.

FIG. 6 shows a second timing diagram including two independent measurement gap patterns and configured SSBs according to various exemplary embodiments.

FIG. 7 shows an exemplary information element (IE) that may be sent via Radio Resource Control (RRC) signaling from the gNB to the UE to configure the sharing of serving cell L1 measurements and RRM measurements.

### DETAILED DESCRIPTION

The exemplary embodiments may be further understood with reference to the following description and the related appended drawings, wherein like elements are provided with the same reference numerals. The exemplary embodiments describe manners of configuring a UE to perform serving cell L1 measurements and/or RRM measurements.

The exemplary embodiments are described with regard to a fifth generation (5G) network that supports multiple independent measurement gap patterns for radio resource management (RRM) measurements. As will be described in greater detail below, the measurement gaps of each measurement gap pattern may fully overlap, partially overlap and/or not overlap. However, it should be understood that the exemplary embodiments are not limited to 5G networks and may be applied to any network that supports multiple independent measurement gap patterns for any type of measurements.

In addition, throughout this description it will be described that a user equipment (UE) will be performing L1 measurements such as RLM measurements, BFD measurements, CBD measurements, L1-RSRP measurements and L1-SINR measurements. It should be understood that these measurements are only exemplary and the exemplary embodiments may be used in conjunction with any type of L1 measurements. In addition, it should be understood that the L1 measurements described herein refer to L1 measurements that are performed for the current serving cell. Those skilled in the art will understand that the UE may also perform L1 mobility measurements on neighbor cells and typically these mobility measurements are performed during a measurement gap when the UE tunes away from the current serving cell. However, the L1 measurements referred to in this description are L1 measurements on the current serving cell.

As described above, a measurement gap may be configured for the UE during which the UE may tune away from the current serving cell to neighbor cells to perform mobility measurements, e.g., L3 RRM measurements. However, it should be understood that there may be circumstances where the UE performs RRM measurements on the current serving cell during a measurement gap, e.g., the UE is not limited to performing neighbor cell RRM measurements in measurement gaps. In addition, while reference is made to L3 measurements performed during the measurement gaps, it should be understood that other types of measurements may also be performed during the measurement gaps. Thus, throughout this description, the term RRM measurements will be used to refer to any measurements performed during the measurement gaps.

In some exemplary embodiments, it will be described that the UE may share measurement opportunities associated with a measurement gap with serving cell L1 measurements. It should be understood that each measurement opportunity may refer to a period of time during which the UE may perform measurements. If the UE is to perform RRM measurements, the UE will use the measurement opportunity associated with a measurement gap and tune away from the serving cell to perform the RRM measurements. If the UE is to perform serving cell L1 measurements, the UE will use the measurement opportunity that corresponds to the time of the measurement gap to perform the serving cell L1 measurements.

Some exemplary embodiments describe a manner of sharing measurement opportunities between RRM measurements performed in a measurement gap and serving cell L1 measurements. A UE may be configured by the network to share various measurement opportunities.

Other exemplary embodiments describe that serving cell L1 measurements are only performed when there are no measurement gaps that overlap with the SSB for the serving cell L1 measurements. In these exemplary embodiments, new scaling factors for the serving cell L1 measurements are provided.

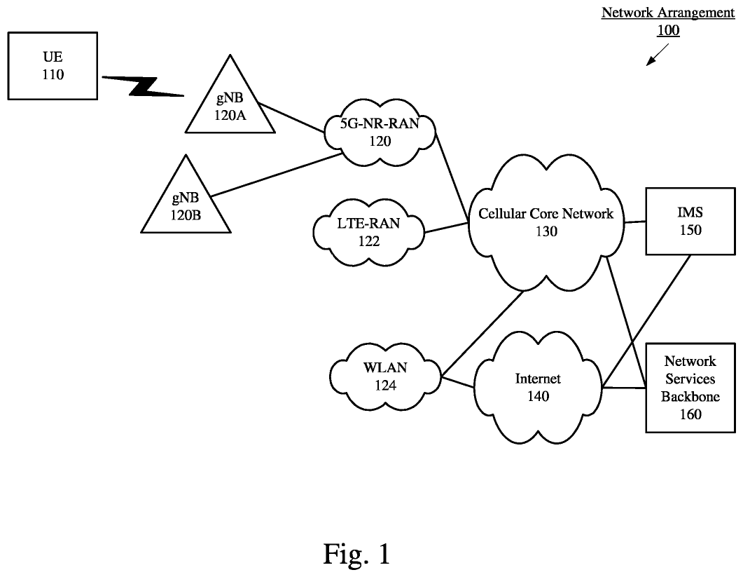

FIG. 1 shows an exemplary network arrangement 100 according to various exemplary embodiments. The exemplary network arrangement 100 includes a user equipment (UE) 110. Those skilled in the art will understand that the UE may be any type of electronic component that is configured to communicate via a network, e.g., a component of a connected car, a mobile phone, a tablet computer, a smartphone, a phablet, an embedded device, a wearable, an Internet of Things (IoT) device, etc. It should also be understood that an actual network arrangement may include any number of UEs being used by any number of users. Thus, the example of a single UE 110 is merely provided for illustrative purposes.

The UE 110 may communicate directly with one or more networks. In the example of the network configuration 100, the networks with which the UE 110 may wirelessly communicate are a 5G NR radio access network (5G NR-RAN) 120, an LTE radio access network (LTE-RAN) 122 and a wireless local access network (WLAN) 124. Therefore, the UE 110 may include a 5G NR chipset to communicate with the 5G NR-RAN 120, an LTE chipset to communicate with the LTE-RAN 122 and an ISM chipset to communicate with the WLAN 124. However, the UE 110 may also communicate with other types of networks (e.g. legacy cellular networks) and the UE 110 may also communicate with networks over a wired connection. With regard to the exemplary embodiments, the UE 110 may establish a connection with the 5G NR-RAN 122.

The 5G NR-RAN 120 and the LTE-RAN 122 may be portions of cellular networks that may be deployed by cellular providers (e.g., Verizon, AT&T, T-Mobile, etc.). These networks 120, 122 may include, for example, cells or base stations (Node Bs, eNodeBs, HeNBs, eNBS, gNBs, gNodeBs, macrocells, microcells, small cells, femtocells, etc.) that are configured to send and receive traffic from UEs that are equipped with the appropriate cellular chip set. The WLAN 124 may include any type of wireless local area network (WiFi, Hot Spot, IEEE 802.11x networks, etc.).

The UE 110 may connect to the 5G NR-RAN via at least one of the next generation nodeB (gNB) 120A and/or the gNB 120B. The gNBs 120A, 120B may be configured with the necessary hardware (e.g., antenna array), software and/or firmware to perform massive multiple in multiple out (MIMO) functionality. Massive MIMO may refer to a base station that is configured to generate a plurality of beams for a plurality of UEs. Reference to two gNBs 120A, 120B is merely for illustrative purposes. The UE 110 may also connect to the LTE-RAN 122 or to any other type of RAN, as mentioned above.

In the example of FIG. 1, it may be considered that the gNB 120A is the current serving cell for the UE 110 and the gNB 120B is a neighbor cell. Thus, the UE 110 will perform serving cell L1 measurements on reference signals transmitted by the gNB 120A and neighbor cell measurements on reference signals transmitted by the gNB 120B. As described above, the neighbor cell measurements may be performed during a measurement gap that is configured by the serving cell gNB 120A.

In addition to the networks 120, 122 and 124 the network arrangement 100 also includes a cellular core network 130, the Internet 140, an IP Multimedia Subsystem (IMS) 150, and a network services backbone 160. The cellular core network 130 may be considered to be the interconnected set of components that manages the operation and traffic of the cellular network. The cellular core network 130 also manages the traffic that flows between the cellular network and the Internet 140. The IMS 150 may be generally described as an architecture for delivering multimedia services to the UE 110 using the IP protocol. The IMS 150 may communicate with the cellular core network 130 and the Internet 140 to provide the multimedia services to the UE 110. The network services backbone 160 is in communication either directly or indirectly with the Internet 140 and the cellular core network 130. The network services backbone 160 may be generally described as a set of components (e.g., servers, network storage arrangements, etc.) that implement a suite of services that may be used to extend the functionalities of the UE 110 in communication with the various networks.

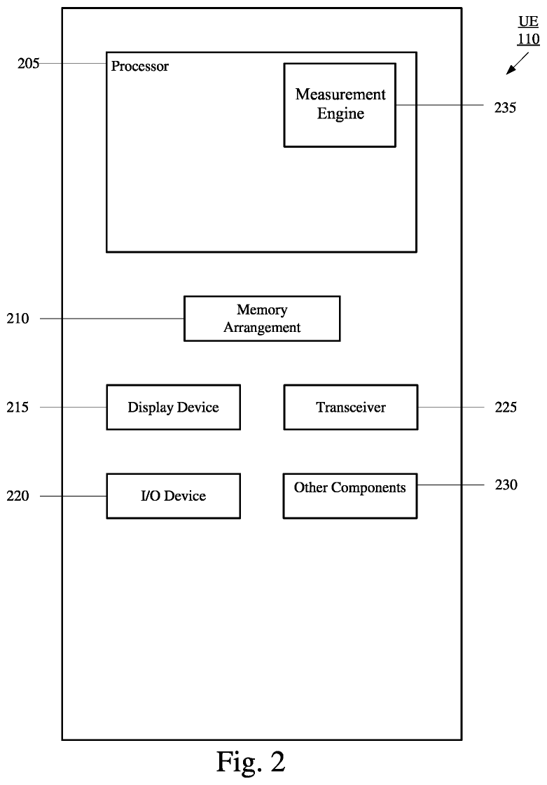

FIG. 2 shows an exemplary UE 110 according to various exemplary embodiments. The UE 110 will be described with regard to the network arrangement 100 of FIG. 1. The UE 110 may represent any electronic device and may include a processor 205, a memory arrangement 210, a display device 215, an input/output (I/O) device 220, a transceiver 225, and other components 230. The other components 230 may include, for example, an audio input device, an audio output device, a battery that provides a limited power supply, a data acquisition device, ports to electrically connect the UE 110 to other electronic devices, sensors to detect conditions of the UE 110, etc.

The processor 205 may be configured to execute a plurality of engines for the UE 110. For example, the engines may include a measurement engine 235. The measurement engine 235 may perform operations relating to the L1 serving cell measurements and the RRM measurements performed during measurement gaps. The specific operations for various scenarios will be described in further detail below.

The above referenced engine being an application (e.g., a program) executed by the processor 205 is only exemplary. The functionality associated with the engines may also be represented as a separate incorporated component of the UE 110 or may be a modular component coupled to the UE 110, e.g., an integrated circuit with or without firmware. For example, the integrated circuit may include input circuitry to receive signals and processing circuitry to process the signals and other information. The engines may also be embodied as one application or separate applications. In addition, in some UEs, the functionality described for the processor 205 is split among two or more processors such as a baseband processor and an applications processor. The exemplary embodiments may be implemented in any of these or other configurations of a UE. The memory 210 may be a hardware component configured to store data related to operations performed by the UE 110.

The display device 215 may be a hardware component configured to show data to a user while the I/O device 220 may be a hardware component that enables the user to enter inputs. The display device 215 and the I/O device 220 may be separate components or integrated together such as a touchscreen. The transceiver 225 may be a hardware component configured to establish a connection with the 5G-NR RAN 120, the LTE RAN 122 etc. Accordingly, the transceiver 225 may operate on a variety of different frequencies or channels (e.g., set of consecutive frequencies).

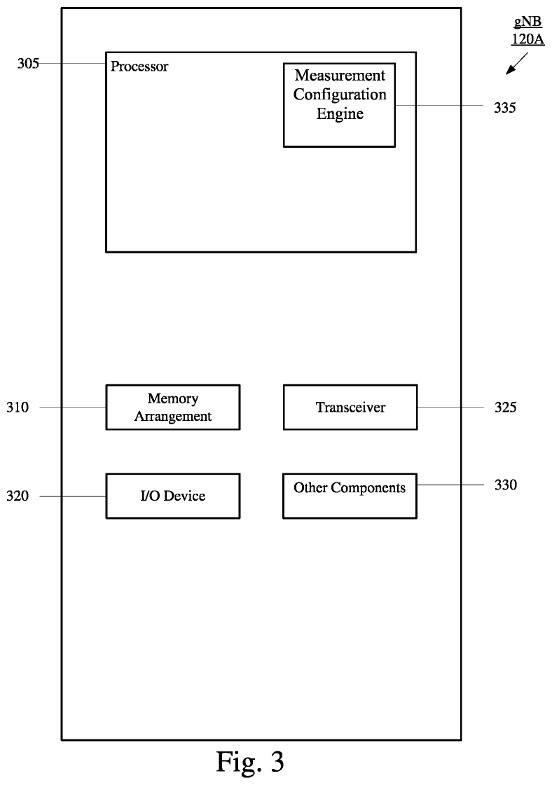

FIG. 3 shows an exemplary base station, in this case gNB 120A, according to various exemplary embodiments. As noted above with regard to the UE 110, the gNB 120A may represent a serving cell for the UE 110. The gNB 120A may represent any access node of the 5G NR network through which the UE 110 may establish a connection and manage network operations, including the gNB 120B.

The gNB 120A may include a processor 305, a memory arrangement 310, an input/output (I/O) device 320, a transceiver 325, and other components 330. The other components 330 may include, for example, an audio input device, an audio output device, a battery, a data acquisition device, ports to electrically connect the gNB 120A to other electronic devices, etc.

The processor 305 may be configured to execute a plurality of engines of the gNB 120A. For example, the engines may include a measurement configuration engine 335. The measurement configuration engine 335 may perform operations including configuring the UE 110 to perform the L1 serving cell measurements and the RRM measurements during measurement gaps. The specific operations for various scenarios will be described in further detail below.

The above noted engines each being an application (e.g., a program) executed by the processor 305 is only exemplary. The functionality associated with the engines may also be represented as a separate incorporated component of the gNB 120A or may be a modular component coupled to the gNB 120A, e.g., an integrated circuit with or without firmware. For example, the integrated circuit may include input circuitry to receive signals and processing circuitry to process the signals and other information. In addition, in some gNBs, the functionality described for the processor 305 is split among a plurality of processors (e.g., a baseband processor, an applications processor, etc.). The exemplary embodiments may be implemented in any of these or other configurations of a gNB.

The memory 310 may be a hardware component configured to store data related to operations performed by the UEs 110, 112. The I/O device 320 may be a hardware component or ports that enable a user to interact with the gNB 120A. The transceiver 325 may be a hardware component configured to exchange data with the UE 110 and any other UE in the network arrangement 100. The transceiver 325 may operate on a variety of different frequencies or channels (e.g., set of consecutive frequencies). Therefore, the transceiver 325 may include one or more components (e.g., radios) to enable the data exchange with the various networks and UEs.

Prior to describing the exemplary measurement operations, the following will provide a general overview of various measurement gap patterns. These measurement gap patterns are described so that it will be understood that the exemplary embodiments may be used in association with any type of measurement gap pattern, i.e., the exemplary embodiments may be described with reference to a particular type of measurement gap pattern, but those skilled in the art will understand how to apply the exemplary embodiments to any type of measurement gap pattern.

As described above, a 5G network may support multiple independent measurement gap patterns for a UE. In each of the following examples, two independent measurement gap patterns are described. However, it should be understood that the network may also support more than two independent measurement gap patterns for the UE and the exemplary embodiments also apply to scenarios where there are more than two independent measurement gap patterns.

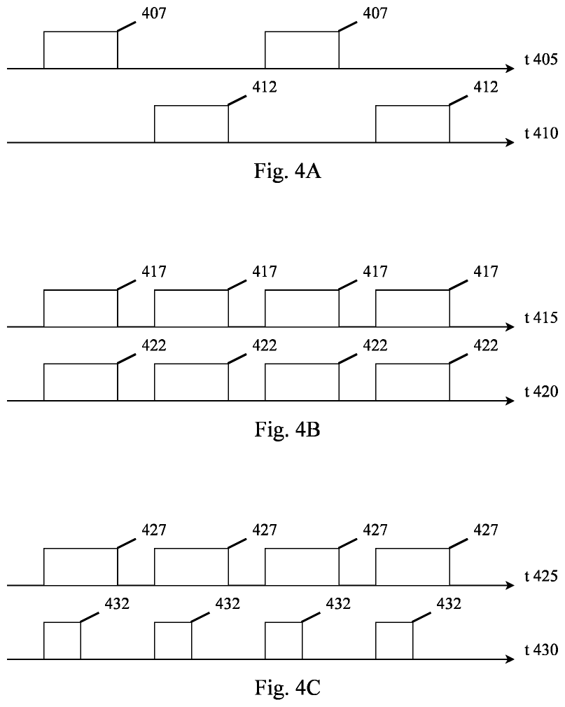

FIG. 4A shows an example of fully non-overlapping independent measurement gap patterns. FIG. 4A shows a first measurement gap pattern 405 having measurement gaps 407 and a second measurement gap pattern 410 having measurement gaps 412. As can be seen from FIG. 4A, none of the measurement gaps 407 overlap with any of the measurement gaps 412, i.e., all the measurement gaps 407 and 412 occur at a different time. Thus, these measurement gap patterns are considered to be fully non-overlapping.

FIG. 4B shows an example of fully overlapping independent measurement gap patterns. FIG. 4B shows a first measurement gap pattern 415 having measurement gaps 417 and a second measurement gap pattern 420 having measurement gaps 422. As can be seen from FIG. 4B, all of the measurement gaps 417 overlap with measurement gaps 422. Thus, these measurement gap patterns are considered to be fully overlapping.

FIG. 4C shows a second example of fully overlapping independent measurement gap patterns. FIG. 4C shows a first measurement gap pattern 425 having measurement gaps 427 and a second measurement gap pattern 430 having measurement gaps 432. The difference between FIG. 4B and FIG. 4C is that the length of the measurement gaps 427 and 432 are different. However, every measurement gap 432 is fully overlapped with a measurement gap 427 and, thus, these measurement gap patterns are also considered to be fully overlapping.

FIG. 4D shows an example of fully-partial overlapping independent measurement gap patterns. FIG. 4D shows a first measurement gap pattern 435 having measurement gaps 437 and a second measurement gap pattern 440 having measurement gaps 442. As can be seen from FIG. 4D, all of the measurement gaps 437 overlap with measurement gaps 442. However, each of the measurement gaps 437 and 442 that overlap are offset with respect to time in such that each measurement gap 437 and 442 includes a time where there are no overlaps. Thus, these measurement gap patterns are considered to be fully-partial overlapping.

FIG. 4E shows an example of partially-fully overlapping independent measurement gap patterns. FIG. 4E shows a first measurement gap pattern 445 having measurement gaps 447 and a second measurement gap pattern 450 having measurement gaps 452. As can be seen from FIG. 4E, all of the measurement gaps 452 are overlapped by the measurement gaps 447. However, there are measurement gaps 447 that do not overlap with any measurement gaps 452. Thus, these measurement gap patterns are considered to be partially-fully overlapping.

FIG. 4F shows an example of partially-partially overlapping independent measurement gap patterns. FIG. 4F shows a first measurement gap pattern 455 having measurement gaps 457 and a second measurement gap pattern 460 having measurement gaps 462. As can be seen from FIG. 4E, all of the measurement gaps 462 are partially overlapped by the measurement gaps 457. However, there are measurement gaps 457 that do not overlap with any measurement gaps 462. Thus, these measurement gap patterns are considered to be partially-partially overlapping.

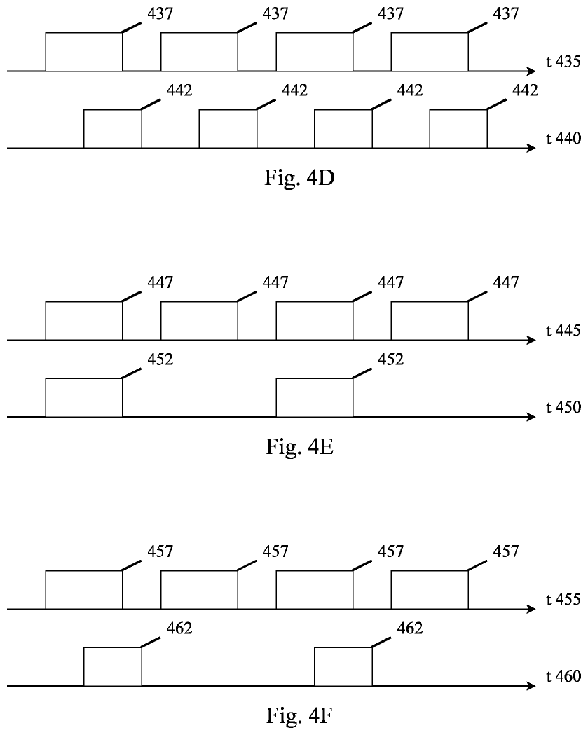

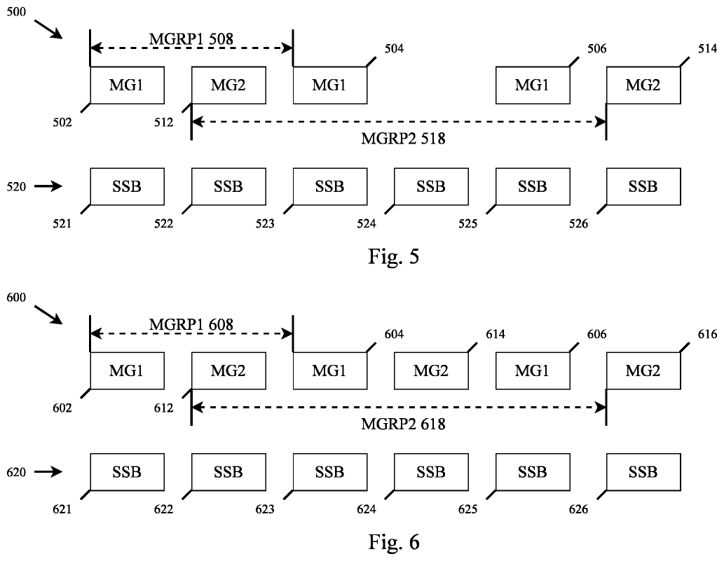

As described above, in some exemplary embodiments, there may be sharing between L1 measurements and certain measurement gap patterns. The sharing between L1 measurements and measurement gap patterns will be described with reference to FIGS. 5-6.

FIG. 5 shows a first timing diagram 500 including two independent measurement gap patterns and configured SSBs according to various exemplary embodiments. FIG. 5 shows a first measurement gap pattern having measurement gaps 502, 504, 506 with a periodicity of MGRP 1 508. FIG. 5 also shows a second measurement gap pattern having measurement gaps 512, 514, with a periodicity of MGRP 2 518. Finally, FIG. 5 also shows an SSB pattern 520 having SSBs 521-526. As described above, the SSBs include reference signals transmitted by a serving cell that may be used for the L1 measurements.

The UE 110 may be configured by the network (e.g., via gNB 120A) to perform measurements based on a set of sharing rules. The sharing rules may include a first exemplary rule where any SSBs that are not overlapped with any measurement gaps, the UE 110 will perform the serving cell L1 measurements. A second exemplary rule may include where any SSBs that are overlapped with an indicated measurement gap pattern, the UE 110 splits the measurement opportunity between the serving cell L1 measurements and RRM measurements according to a configured sharing scheme to be explained in greater detail below. A third exemplary rule may include where any SSBs are overlapped with a non-indicated measurement gap pattern, the UE 110 performs the RRM measurements.

These exemplary sharing rules will now be applied to the first exemplary timing diagram 500 of FIG. 5. In applying these rules, it may be considered that the indicated measurement gap pattern is the first measurement gap pattern including the measurement gaps 502, 504, 506. Thus, applying the first exemplary rule of where any SSBs that are not overlapped with any measurement gaps, the UE 110 will perform the serving cell L1 measurements, the UE 110 will perform the serving cell L1 measurements for SSB 524 because it is not overlapped with any of the measurement gaps. Applying the third exemplary rule where any SSBs that are overlapped with a non-indicated measurement gap pattern, the UE 110 performs the RRM measurements during the measurement gaps 512 and 514 because those measurement gaps are associated with a non-indicated measurement gap pattern. This means that the UE 110 does not perform the serving cell L1 measurements for SSBs 522 and 526.

Applying the second exemplary rule may where any SSBs that are overlapped with an indicated measurement gap pattern, the UE 110 will split the measurement opportunity between the serving cell L1 measurements and RRM measurements. In this example, it may be considered that network has configured the sharing to be ⅔ for RRM measurements and ⅓ for serving cell L1 measurements. This means that for every three (3) overlapping SSBs/measurement gaps, two (2) will be allocated to the RRM measurements and one (1) will be allocated to the serving cell L1 measurements. Thus, in this example, it may be considered that the first two measurement gaps 502, 504 of the indicated measurement gap pattern are used for RRM measurements (e.g., the UE 110 does not perform the serving cell L1 measurements for SSBs 521 and 523) and during the third measurement gap 506 of the indicated measurement gap pattern, the UE 110 performs the serving cell L1 measurements for SSBs 525.

It should be understood that the ⅔ RRM measurements−⅓ L1 measurements split is only exemplary and other types of splits may be used. Some further examples of splits will be described in greater detail below. It should also be understood that the ⅔ split does not require that the first two measurement gaps be used for the RRM measurements, e.g., the L1 measurement may be performed first and then the two RRM measurements may be performed, or the two RRM measurements may be separated by the L1 measurement.

FIG. 6 shows a second timing diagram 600 including two independent measurement gap patterns and configured SSBs according to various exemplary embodiments. FIG. 6 shows a first measurement gap pattern having measurement gaps 602, 604, 606 with a periodicity of MGRP 1 608. FIG. 6 also shows a second measurement gap pattern having measurement gaps 612, 614, 616 with a periodicity of MGRP 2 618. Finally, FIG. 6 also shows an SSB pattern 620 having SSBs 621-626.

The exemplary sharing rules will now be applied to the second exemplary timing diagram 600 of FIG. 6. Similar to the above example, it may be considered that the indicated measurement gap pattern is the first measurement gap pattern including the measurement gaps 602, 604, 606. Thus, the first exemplary rule is not applicable because there are no SSBs that are not overlapped with any measurement gaps. Applying the third exemplary rule where any SSBs that are overlapped with a non-indicated measurement gap pattern, the UE 110 performs the RRM measurements during the measurement gaps 612, 614 and 616 because those measurement gaps are associated with a non-indicated measurement gap pattern. This means that the UE 110 does not perform the serving cell L1 measurements for SSBs 622, 624 and 626.

Applying the second exemplary rule may where any SSBs that are overlapped with an indicated measurement gap pattern, the UE 110 will split the measurement opportunity between the serving cell L1 measurements and RRM measurements. Again, in this example, it may be considered that network has configured the sharing to be ⅔ for RRM measurements and ⅓ for serving cell L1 measurements. Thus, in this example, it may be considered that the first two measurement gaps 602, 604 of the indicated measurement gap pattern are used for RRM measurements (e.g., the UE 110 does not perform the serving cell L1 measurements for SSBs 621 and 623) and during the third measurement gap 606 of the indicated measurement gap pattern, the UE 110 performs the serving cell L1 measurements for SSBs 625.

From the above examples, it can be seen how applying the exemplary sharing rules allows the UE 110 to share measurement opportunities between the serving cell L1 measurements and RRM measurements performed in a measurement gap. As also described above, the exemplary sharing rules may be used for any type of measurement gap pattern and any number of measurement gap patterns that are configured for a UE 110.

As described above, the 5G network may indicate measurement gap pattern which shares the measurement opportunity with the serving cell L1 measurements, e.g., the indicated measurement gap pattern. In some examples, this information may be shared via Radio Resource Control (RRC) signaling between the gNB 120A and the UE 110. As part of this RRC signaling the 5G network may also indicate the sharing scheme, examples of which will be further described below.

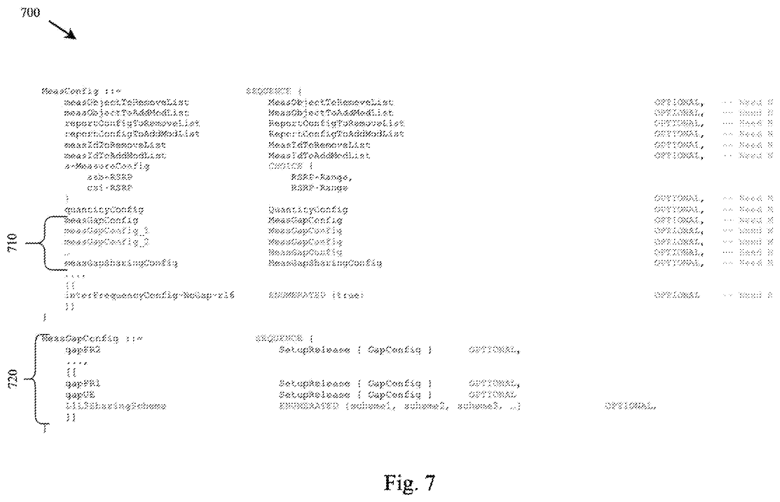

FIG. 7 shows an exemplary information element (IE) 700 that may be sent via RRC signaling from the gNB 120A to the UE 110 to configure the sharing of serving cell L1 measurements and RRM measurements. The following will provide a brief description of the fields that may be included in the IE 700 to configure the sharing of serving cell L1 measurements and RRM measurements. Not all fields of the IE 700 are described.

The bracket 710 shows a first set of fields that may be used to configure the sharing of serving cell L1 measurements and RRM measurements. The fields measGapConfig_1 and measGapConfig_2 may be used to define each of the independent measurement gap patterns. In this example, there are again two independent measurement gap patterns. Thus, when the UE 110 receives this portion of the IE 700, the UE 110 will understand that the network has configured two independent measurement gap patterns for the UE 110. Also included in the bracket 710 is a field measGapSharingConfig. When the UE 110 receives this field (e.g., when this field is set to TRUE or otherwise indicated as active), the UE 110 will understand that the network has configured the UE 110 to share serving cell L1 measurements and RRM measurements.

The bracket 720 shows a second set of fields that configures the particular measurement gap patterns, e.g., measGapConfig_1 or measGapConfig_2, e.g., the number of gaps, the periodicity, the length of the gaps, etc. In this example, it may be considered that the fields configure measGapConfig_1. The fields include an L1L3SharingScheme field that indicates to the UE 110 that this measurement gap pattern is to be used for sharing the serving cell L1 measurements. In this example, the field is populated with a particular sharing scheme, e.g., scheme1, scheme2, scheme3, etc. The sharing scheme may define the how the UE 110 is to share the measurement opportunities between the RRM measurements and the serving cell L1 measurements.

For example, scheme1 may represent the sharing scheme described above, e.g., ⅔ for RRM measurements and ⅓ for serving cell L1 measurements. The scheme2 may represent an equal sharing scheme, e.g., ½ for RRM measurements and ½ for serving cell L1 measurements. The scheme3 may represent a sharing scheme that favors the serving cell L1 measurements, e.g., ⅔ for serving cell L1 measurements and ⅓ for RRM measurements. Again, it should be understood that these sharing schemes are only exemplary and other sharing schemes may be defined based on any number of factors. For example, when the UE 110 is in a high state of mobility, the sharing scheme may favor the RRM measurements because it is likely that a handover will occur and neighbor cell measurements may have a priority in such scenarios. On the other hand, when the UE 110 is in a low state of mobility, the sharing scheme may favor the serving cell L1 measurements because the UE 110 is attempting to maintain optimum channel conditions with the current serving cell.

In some exemplary embodiments, the sharing scheme may be fixed, e.g., such as ⅔ for RRM measurements and ⅓ for serving cell L1 measurements or any other sharing scheme. In these exemplary embodiments, the sharing scheme does not need to be signaled in the IE 700 because the sharing scheme is fixed and the UE 110 will follow the fixed scheme when signaled that sharing is to occur.

In other exemplary embodiments, the UE 110 may perform the serving cell L1 measurements outside of the configured measurement gaps. For example, referring to FIG. 5, the UE 110 may only perform the serving cell L1 measurements for the SSB 524 because it is the only SSB to occur outside of the configured measurement gaps. Thus, the UE 110 will perform the RRM measurements within the configured measurement gaps and perform the serving cell L1 measurements outside of the configured measurement gaps.

In current specifications, a scaling factor (P) may be applied to extend a measurement period for L1 measurements. However, the scaling factor (P) may have to be revised for the scenario where there are multiple independent measurement gap patterns defined for the UE 110. The following will provide multiple scenarios and the corresponding scaling factor (P) for each of the scenarios.

In a first exemplary scenario, in frequency range 1 (FR1), there are multiple independent measurement gaps that are fully non-overlapping and some but not all measurement gaps overlap with occasions of the SSB. The scaling factor (P) is as follows:

$$P = \frac{1}{1 - {\sum }_{i = 1}^{n} \frac{{T}_{SSB}}{{MGRP}_{i}}}$$

where n is the number of configured measurement gap patterns, MGRPi is the measurement gap repetition period (MGRP) of the i^{th} measurement gap pattern and T_{SSB} is the time of the SSB.

Otherwise, when there are no measurement gaps overlapping with any occasion of the SSB, P=1.

In a second exemplary scenario, in frequency range 2 (FR2), there are multiple independent measurement gaps that are fully non-overlapping, the SSB is not overlapped with any measurement gaps and the SSB is partially overlapped with a SS block based RRM measurement timing configuration (SMTC) occasion (e.g., T_{SSB}<T_{SMTCperiod}). The scaling factor (P) is as follows:

$$P = \frac{1}{1 - \frac{{T}_{SSB}}{{T}_{SMTCperíod}}}$$

In a third exemplary scenario, in FR2, there are multiple independent measurement gaps that are fully non-overlapping, the SSB is not overlapped with any measurement gaps and the SSB is fully overlapped with the SMTC period (e.g., T_{SSB}=T_{SMTCperiod}). The scaling factor (P) for this scenario is P_{sharing factor}. The P_{sharing factor} is defined as if the SSB configured for L1-RSRP measurement outside measurement gap is not overlapped with the SSB symbols indicated by SSB-ToMeasure and 1 data symbol before each consecutive SSB symbols indicated by SSB-ToMeasure and one (1) data symbol after each consecutive SSB symbols indicated by SSB-ToMeasure, given that SSB-ToMeasure is configured, where the SSB-ToMeasure is the union set of SSB-ToMeasure from all the configured measurement objects merged on the same serving carrier, and, is also not overlapped with the RSSI symbols indicated by ss-RSSI-Measurement and 1 data symbol before each RSSI symbol indicated by ss-RSSI-Measurement and one (1) data symbol after each RSSI symbol indicated by ss-RSSI-Measurement, given that ss-RSSI-Measurement is configured, then P_{sharing factor}=1. Otherwise, the P_{sharing factor}=3.

In a fourth exemplary scenario, in FR2, there are multiple independent measurement gaps that are fully non-overlapping, the SSB is partially overlapped with a measurement gap, the SSB is partially overlapped with the SMTC occasion (e.g., T_{SSB}<T_{SMTCperiod}) and the SMTC occasion is not overlapped with a measurement gap. The scaling factor (P) is as follows:

$$P = \frac{1}{1 - {\sum }_{i = 1}^{n} \frac{{T}_{SSB}}{{MGRP}_{i}} - \frac{{T}_{SSB}}{{T}_{SMTCperíod}}} :$$

In a fifth exemplary scenario, in FR2, there are multiple independent measurement gaps that are fully non-overlapping, the SSB is partially overlapped with a measurement gap, the SSB is partially overlapped with the SMTC occasion (T_{SSB}<T_{SMTCperiod}) and the SMTC occasion is partially or fully overlapped with a measurement gap. The scaling factor (P) is as follows:

$$P = \frac{1}{1 - \frac{{T}_{SSB}}{min ( {T}_{SMTCperíod} , {MGRP}_{1} , {MGRP}_{2} , … )}} :$$

In a sixth exemplary scenario, in FR2, there are multiple independent measurement gaps that are fully non-overlapping, the SSB is partially overlapped with a measurement gap, the SSB is fully overlapped with the SMTC occasion (e.g., T_{SSB}=T_{SMTCperiod}) and the SMTC occasion is partially overlapped with a measurement gap. The scaling factor (P) is as follows:

$$P = \frac{{P}_{sharing factor}}{1 - {\sum }_{i = 1}^{n} \frac{{T}_{SSB}}{{MGRP}_{i}}} :$$

Those skilled in the art will understand that the above-described exemplary embodiments may be implemented in any suitable software or hardware configuration or combination thereof. An exemplary hardware platform for implementing the exemplary embodiments may include, for example, an Intel x86 based platform with compatible operating system, a Windows OS, a Mac platform and MAC OS, a mobile device having an operating system such as iOS, Android, etc. In a further example, the exemplary embodiments of the above described method may be embodied as a program containing lines of code stored on a non-transitory computer readable storage medium that, when compiled, may be executed on a processor or microprocessor.

Although this application described various embodiments each having different features in various combinations, those skilled in the art will understand that any of the features of one embodiment may be combined with the features of the other embodiments in any manner not specifically disclaimed or which is not functionally or logically inconsistent with the operation of the device or the stated functions of the disclosed embodiments.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

It will be apparent to those skilled in the art that various modifications may be made in the present disclosure, without departing from the spirit or the scope of the disclosure. Thus, it is intended that the present disclosure cover modifications and variations of this disclosure provided they come within the scope of the appended claims and their equivalent.

1. A processor configured to:
process a layer 1 (L1) measurement configuration for serving cell L1 measurements;
process a measurement gap configuration comprising multiple independent measurement gap patterns to perform radio resource management (RRM) measurements, wherein the measurement gap configuration further comprises an indication that measurement opportunities associated with measurement gaps of one of the multiple independent measurement gap patterns are to be shared with the serving cell L1 measurements; and
perform the serving cell L1 measurements and the RRM measurements in accordance with the L1 measurement configuration and the measurement gap configuration.

2. The processor of claim 1, wherein the serving cell L1 measurements comprise one of Radio Link Monitoring (RLM) measurements, Beam Failure Detection (BFD) measurements, Candidate Beam Discovery (CBD) measurements, reference signal received power (L1-RSRP) measurements and signal-to-noise and interference ratio (L1-SINR) measurements.

3. The processor of claim 1, wherein the serving cell L1 measurements are based on reference signals for L1 measurements associated with a system synchronization blocks (SSBs) or Channel State Information Reference Signals (CSI-RS) transmitted by a serving cell.

4. The processor of claim 3, wherein, when a reference signal for L1 measurements overlaps with a measurement gap of the one of the multiple independent measurement gap patterns, one of the serving cell L1 measurements or the RRM measurements are performed based on a sharing scheme.

5. The processor of claim 4, wherein the serving cell L1 measurements are performed when a reference signal for L1 measurements does not overlap with any measurement gap of the multiple independent measurement gap patterns.

6. The processor of claim 4, wherein the RRM measurements are performed during any measurement gap that is not associated with the one of the multiple independent measurement gap patterns.

7. The processor of claim 4, wherein the sharing scheme comprises a ratio of L1 measurements to RRM measurements.

8. The processor of claim 4, wherein the sharing scheme is one of signaled in the measurement gap configuration or fixed.

9. The processor of claim 1, wherein the L1 measurement configuration and the measurement gap configuration are received via radio resource configuration (RRC) signaling.

10. A user equipment (UE), comprising:
a transceiver configured to connect to a serving cell; and
a processor communicatively coupled to the transceiver and configured to:
process a layer 1 (L1) measurement configuration for serving cell L1 measurements;
process a measurement gap configuration comprising multiple independent measurement gap patterns to perform radio resource management (RRM) measurements, wherein the measurement gap configuration further comprises an indication that measurement opportunities associated with measurement gaps of one of the multiple independent measurement gap patterns are to be shared with the serving cell L1 measurements; and
perform the serving cell L1 measurements and the RRM measurements in accordance with the L1 measurement configuration and the measurement gap configuration.

11. The UE of claim 10, wherein the serving cell L1 measurements comprise one of Radio Link Monitoring (RLM) measurements, Beam Failure Detection (BFD) measurements, Candidate Beam Discovery (CBD) measurements, reference signal received power (L1-RSRP) measurements and signal-to-noise and interference ratio (L1-SINR) measurements.

12-16. (canceled)

17. A processor configured to:
generate, for transmission to a user equipment (UE), a layer 1 (L1) measurement configuration for serving cell L1 measurements; and
generate, for transmission to the UE, a measurement gap configuration comprising multiple independent measurement gap patterns to perform radio resource management (RRM) measurements, wherein the measurement gap configuration further comprises an indication that measurement opportunities associated with measurement gaps of one of the multiple independent measurement gap patterns are to be shared with the serving cell L1 measurements,
wherein the UE is to perform the serving cell L1 measurements and the RRM measurements in accordance with the L1 measurement configuration and the measurement gap configuration.

18. The processor of claim 17, wherein the serving cell L1 measurements comprise one of Radio Link Monitoring (RLM) measurements, Beam Failure Detection (BFD) measurements, Candidate Beam Discovery (CBD) measurements, reference signal received power (L1-RSRP) measurements and signal-to-noise and interference ratio (L1-SINR) measurements.

19. The processor of claim 17, further configured to:
generate, for transmission to the UE, reference signals for L1 measurements associated with system synchronization blocks (SSBs) or Channel State Information Reference Signals (CSI-RS) in accordance with the measurement configuration, wherein the L1 measurements by the UE are based on the SSBs.

20. The processor of claim 19, wherein the L1 measurement configuration and the measurement gap configuration comprise a reference signal for L1 measurements that overlaps with a measurement gap of the one of the multiple independent measurement gap patterns, wherein the UE is configured to perform one of the serving cell L1 measurements or the RRM measurements based on a sharing scheme.

21. The processor of claim 20, wherein the L1 measurement configuration and the measurement gap configuration comprise a reference signal for L1 measurements that does not overlap with any measurement gap of the multiple independent measurement gap patterns, wherein the UE is configured to perform the serving cell L1 measurements for the SSBs.

22. The processor of claim 20, wherein the measurement gap configuration configures the UE to perform RRM measurements during any measurement gap that is not associated with the one of the multiple independent measurement gap patterns.

23. The processor of claim 20, wherein the sharing scheme comprises a ratio of L1 measurements to RRM measurements.

24. The processor of claim 20, wherein the sharing scheme is signaled in the measurement gap configuration.

25. The processor of claim 17, wherein the L1 measurement configuration and the measurement gap configuration are transmitted via radio resource configuration (RRC) signaling.
